(19) United States
(12) Patent Application Publication
(10) Pub. No.: US 2025/0122445 A1
(43) Pub. Date: Apr. 17, 2025

(54) CONCENTRATED FABRIC CONDITIONER

(71) Applicant: Conopco, Inc., d/b/a UNILEVER, Englewood Cliffs, NJ (US)

(72) Inventors: Thatiana Guisolphe CASTRO, São Paulo (BR); Leandro Augusto de Paula EDUARDO, Campinas-São Paulo (BR)

(73) Assignee: Conopco, Inc., d/b/a UNILEVER, Englewood Cliffs, NJ (US)

(21) Appl. No.: 18/845,282

(22) PCT Filed: Mar. 8, 2023
(86) PCT No.: PCT/EP2023/055855

§ 371 Date: Sep. 9, 2024

(30) Foreign Application Priority Data
Mar. 10, 2022 (EP) 22161361.5

(51) Int. Cl. C11D 1/62; C11D 1/83; C11D 3/00; C11D 3/33; C11D 3/50

(52) U.S. Cl. CPC C11D 1/62; C11D 1/83; C11D 3/0015; C11D 3/33; C11D 3/502

(57) ABSTRACT

A concentrated fabric conditioner composition comprising: a) 5 to 80 wt. % fabric softening active; and b) ethylenediaminetetraacetic acid or a salt thereof.

### FIELD OF THE INVENTION

The present invention is in the field of dilutable fabric conditioner compositions. These are compositions which the consumer purchases in a concentrated form and dilutes before use.

### BACKGROUND OF THE INVENTION

Dilute at home products are becoming more common. Such products are purchased in a concentrated form and are diluted by the consumer before use. Dilute at home laundry products provide various benefits: concentrated products are smaller and lighter, therefore easier to transport and requiring less packaging. However, if used in their concentrated form these products may lead to overdosing and damage to the laundered fabrics. By allowing the consumer to dilute the product themselves, they have the benefits of smaller and lighter products to carry home, then once diluted, can use the product following to their habitual laundry routine.

In the field of fabric conditioners, providing a concentrated product which can be diluted and used by the consumer is challenging. Consumers may dilute a concentrated product and then use the diluted product over a period of months. The product must therefore be stable and have a suitable viscosity both in the concentrated form and in the diluted form. Additionally, the dilution process must be easy for the consumer and not require excessive effort to disperse the concentrated product in water.

### SUMMARY OF THE INVENTION

It has been found that by incorporating ethylenediaminetetraacetic acid or a salt thereof into a dilute at home product, a concentrated fabric conditioner composition can be obtained which has improved rheology properties.

Accordingly in one aspect of the present invention is provided a concentrated fabric conditioner composition comprising:
a) 5 to 80 wt. % fabric softening active;
b) ethylenediaminetetraacetic acid or a salt thereof.

The invention further relates to a method of preparing a diluted fabric conditioner, wherein the concentrated fabric conditioner as described herein is mixed with water, prior to addition to the laundry process.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Fabric Softening Active

The fabric conditioners described herein comprise fabric softening actives. The fabric softening actives are preferably cationic or non-ionic materials. Preferably, the fabric softening actives of the present invention are cationic materials. The fabric conditioners described herein preferably comprise quaternary ammonium compounds (QAC).

The QAC preferably comprises at least one chain derived from fatty acids, more preferably at least two chains derived from a fatty acid. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats” or ester linked quaternary ammonium compounds. Particularly preferred materials are the ester-linked triethanolamine (TEA) quaternary ammonium compounds comprising a mixture of mono-, di- and tri-ester linked components. Typically, TEA-based fabric softening compounds comprise a mixture of mono, di- and tri ester forms of the compound where the di-ester linked component comprises no more than 70 wt. % of the fabric softening compound, preferably no more than 60 wt. % e.g., no more than 55%, or even no more that 45% of the fabric softening compound and at least 10 wt. % of the monoester linked component.

A first group of quaternary ammonium compounds (QACs) suitable for use in the present invention is represented by formula (I):

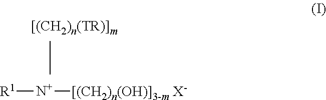

wherein each R is independently selected from a C5 to C35 alkyl or alkenyl group; R¹ represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e., m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Praepagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

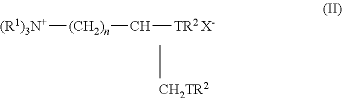

wherein each R¹ group is independently selected from C1 to C4 alkyl, hydroxyalkyl or C2 to C4 alkenyl groups; and wherein each R² group is independently selected from C8 to C28 alkyl or alkenyl groups; and wherein n, T, and X-are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N*—[(CH₂)ₙ-T-R²]₂X⁻ (III)

wherein each R¹ group is independently selected from C1 to C4 alkyl, or C2 to C4 alkenyl groups; and wherein each R² group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the third group of QACs is represented the by the formula (IV):

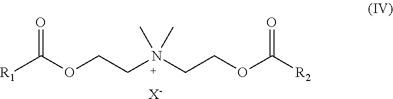

A fourth group of QACs suitable for use in the invention are represented by formula (V)

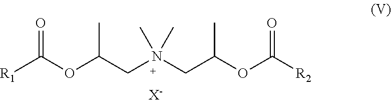

R₁ and R₂ are independently selected from C10 to C22 alkyl or alkenyl groups, preferably C14 to C20 alkyl or alkenyl groups. X— is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains. If there is a mixture of quaternary ammonium materials present in the composition, the iodine value, referred to above, represents the mean iodine value of the parent fatty acyl compounds or fatty acids of all the quaternary ammonium materials present. Likewise, if there are any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (VI):

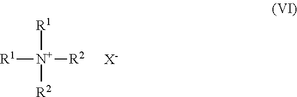

wherein each R¹ group is independently selected from C1 to C4 alkyl, hydroxyalkyl or C2 to C4 alkenyl groups; R² group is independently selected from C8 to C28 alkyl or alkenyl groups, and X— is as defined above.

Preferably the fabric conditioners of the present invention comprise more than 5 wt. % fabric softening active, more preferably more than 6 wt. % fabric softening active, most preferably more than 7 wt. % fabric softening active by weight of the composition. Preferably the fabric conditioners of the present invention comprise less than 90 wt. % fabric softening active, more preferably less than 75 wt. % fabric softening active, most preferably less than 60 wt. % fabric softening active by weight of the composition. Suitably the fabric conditioners comprise 5 to 90 wt. % fabric softening active, preferably 6 to 75 wt. % fabric softening active and more preferably 7 to 60 wt. % fabric softening active by weight of the composition.

### Ethylenediaminetetraacetic Acid

The concentrated fabric conditioners described herein comprise ethylenediaminetetraacetic acid or a salt thereof. An example of a suitable salt is tetrasodium ethylenediaminetetraacetic acid. Preferably they comprise 0.01 to 10 wt. % ethylenediaminetetraacetic acid or a salt thereof, more preferably 0.05 to 5 wt. % ethylenediaminetetraacetic acid or a salt thereof, most preferably 0.1 to 3 wt. % ethylenediaminetetraacetic acid or a salt thereof by weight of the composition.

### Non-Ionic Surfactant

The compositions of the present invention preferably comprise nonionic surfactant by weight of the composition. The non-ionic surfactant preferably comprises a fatty alcohol ethoxylate, preferably the non-ionic surfactant contains fatty alcohol ethoxylate. The fatty alcohol ethoxylate preferably comprises a fatty alcohol chain comprising 10 to 18 carbon atoms. Preferably the fatty alcohol chain comprises 10 to 16 carbon atoms, more preferably 12 to 16 carbon atoms and most preferably 12 to 14 carbon atoms. The fatty alcohol ethoxylate may comprise any number of ethoxylate groups. Preferably 1 to 30 ethoxylate groups, preferably 1 to 20 ethoxylate and most preferably 2 to 10 ethoxylate groups.

The compositions described herein preferably comprises 2 to 30 wt. % non-ionic surfactant, more preferably 4 to 20 wt. % non-ionic surfactant and most preferably 5 to 15 wt. % non-ionic surfactant by weight of the composition.

Where a non-ionic surfactant is present, the ratio of fabric softening active to non-ionic surfactant is preferably 3:1 to 1:1, more preferably 2.5:1 to 1:1, most preferably 2:1 to 1:1 by weight.

### Rheology Modifier

The compositions described herein preferably comprise a rheology modifier. Preferably the composition comprises 0.01 wt. % to 2 wt. % rheology modifier, more preferably 0.05 to 1 wt. %, most preferably 0.1 wt. % to 0.7 wt. % by weight of weight of the fabric conditioner composition.

Suitable rheology modifiers are preferably polymeric materials. The rheology modifier may be synthetic or alternatively the rheology modifier may be wholly or partly derived from natural sources such as cellulosic fibres (for example, microfibrillated cellulose, which may be derived from a bacterial, fungal, or plant origin, including from wood).

Naturally derived polymeric rheology modifiers may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof.

Synthetic polymeric rheology modifiers may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C1-C30 alkyl ester of the (meth) acrylic acid. Such copolymers are available from Noveon Inc. under the tradename Carbopol Aqua 30. Another suitable structurant is sold under the tradename Rheovis CDE, available from BASF.

Preferably the rheology modifier is selected from polyacrylates, polysaccharides, polysaccharide derivatives, or combinations thereof. Polysaccharide derivatives typically used as rheology modifiers comprise polymeric gum materials. Such gums include pectin, alginate, arabinogalactan (gum Arabic), carrageenan, gellan gum, xanthan gum and guar gum. The rheology modifier may preferably be a cationic polymer. Cationic polymer refers to polymers having an overall positive charge. Cationic polymers may comprise non-cationic structural units, but the rheology modifier preferably have a net cationic charge. Preferred synthetic rheology modifiers comprise may comprise: acrylamide structural units, methacrylate structural units, acrylate structural units, methacrylic acid units and combinations thereof.

The rheology modifier may preferably be cross-linked. Preferably the rheology modifier is crosslinked with 50 to 1000 ppm of a difunctional vinyl addition monomer cross-linking agent. Particularly preferred crosslinked polymers are cross-linked copolymers of acrylamide and methacrylate cross-linked with a difunctional vinyl addition monomer, such as methylene bisacrylamide. Preferred cationic cross-linked polymers are derivable from the polymerization of from 5 to 100 mole percent of cationic vinyl addition monomer, from 0 to 95 mole percent of acrylamide and from 50 to 1000 ppm of a difunctional vinyl addition monomer cross-linking agent. Particularly preferred polymers are copolymers of 20% acrylamide and 80% MADAM methyl chloride (MADAM: dimethyl amino ethyl methacrylate) cross-linked with from 450 to 600 ppm of methylene bisacrylamide.

In one embodiment, the rheology modifier may be a cationic acrylamide copolymer which is a cationic copolymer obtained by Hofmann rearrangement in aqueous solution in the presence of an alkali and/or alkaline earth hydroxide and an alkali and/or alkaline earth hypohalide, on a base copolymer comprising:
(i) at least 5 mole % of a non-ionic monomer selected from the group consisting of acrylamide, methacrylamide, N,N-dimethylacrylamide, acrylonitrile, and combinations thereof; and
(ii) at least one comonomer selected from the group consisting of unsaturated cationic ethylenic comonomer, non-ionic comonomer, or combinations thereof, provided that the non-ionic comonomer is not acrylamide, methacrylamide, N,N-dimethylacrylamide, or acrylonitrile.

The cationic copolymer thus obtained has a desalination coefficient (Cd) of greater than 0.6 (e.g., greater than 0.65 and greater than 0.7). Cd is calculated as Real polymeric active matter (% by weight of the copolymer) x Polymer filler density Conductivity of the solution containing 9% of active matter. See also U.S. Pat. No. 8,242,215.

The unsaturated cationic ethylenic comonomer can be selected from the group consisting of dialkylaminoalkyl(meth)acrylamide monomers, diallylamine monomers, methyldiallylamine monomers, and quaternary ammonium salts or acids thereof, such as dimethyldiallylammonium chloride (DADMAC), acrylamidopropyltrimethyl-ammonium chloride (APTAC), methacrylamidopropyltrimethylammonium chloride (MAPTAC). Examples of the non-ionic comonomer are N-vinyl acetamide, N-vinyl formamide, N-vinylpyrrolidone, vinyl acetate, and combinations thereof.

The base copolymer is preferably branched in the presence of a branching agent selected from the group consisting of methylene bisacrylamide, ethylene glycol di-acrylate, polyethylene glycol dimethacrylate, diacrylamide, cyanomethylacrylate, vinyloxyethylacrylate, vinyloxyethylmethacrylate, triallylamine, formaldehyde, glyoxal, and a glycidylether type compound. More examples of the cationic acrylamide copolymers can be found in U.S. Pat. No. 8,242,215.

Examples of suitable rheology modifiers are commercially available from SNF Floerger under the trade names Flosoft FS 200, Flosoft FS 222, Flosoft FS 555, and Flosoft FS 228 and are commercially available from BASF under the trade names Rehovis CDE and Rehovis FRC. See also WO 2007141310, US 20060252668, and US 20100326614.

### Perfume

The compositions described herein preferably comprise perfume. Where present, the compositions preferably comprise 0.1 to 30 wt. % perfume materials, i.e., free perfume and/or perfume microcapsules. As is known in the art, free perfumes and perfume microcapsules provide the consumer with perfume hits at different points during the laundry process. It is particularly preferred that the compositions of the present invention comprise a combination of both free perfume and perfume microcapsules.

Preferably the compositions of the present invention comprise 0.1 to 20 wt. % perfume materials, more preferably 0.2 to 15 wt. % perfume materials, most preferably 0.5 to 10 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprises 0.1 to 15 wt. % free perfume, more preferably 0.5 to 8 wt. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.01 to 10 wt. % perfume microcapsules, more preferably 0.05 to 5 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Other Ingredients

The compositions as described herein may comprise other ingredients as will be known to the person skilled in the art. Among such materials there may be mentioned: antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids.

The products of the invention may contain pearlisers and/or opacifiers. A preferred sequestrant is HEDP, an abbreviation for Etidronic acid or 1-hydroxyethane 1,1-diphosphonic acid.

Preferably the composition is in an aqueous form. The compositions preferably comprise at least 50 wt. % water, more preferably at least 60 wt. %.

### Viscosity

The composition of the present invention preferably has a viscosity of 300 mPa·s to 500 mPa·s. When diluted the diluted composition preferably has a viscosity of 5 mPa·s to 80 mPa·s.

Viscosity is measured at Thermo Scientific Haake Viscotester 550 with a MV1 Sensor System for 15 seconds using 106 viscosity range with temperature of 25° C.

### Method of Diluting

In one aspect of the present invention is provided a method of in-home preparation of a fabric conditioner, wherein an aqueous concentrated fabric conditioner as described herein is mixed with water to produce an aqueous fabric conditioner composition. The mixing, or dilution takes place prior to the laundry process. The fabric conditioner prepared by the method described herein can then be used in a laundry process. The laundry process is defined as the process in which clothes are washed, rinsed and dried. In other words, the mixing with water takes place before the fabric conditioner composition is added to the washing machine (drum or drawer) or before the fabric conditioner is added to the receptacle in which hand washing occurs. The consumer may prepare the liquid fabric conditioner just before the laundry process or may prepare the liquid fabric conditioner days or weeks before using it in the laundry process.

The concentrated fabric conditioning composition may be diluted with water in any suitable receptacle, for example a bottle, a jug, a pot, a box, a bowl, i.e. any container suitable for containing a liquid composition. Preferably the receptacle has means for closing the receptible, i.e. for sealing the liquid fabric conditioner composition within the receptacle, for example a lid. Preferably a bottle is used, preferably the bottle has a lid.

Generally, the consumer may have a ‘keeper’ bottle. This may be a bottle provided especially for the purpose of mixing and storing the diluted fabric conditioner or may be an old bottle previously purchased. The ‘keeper’ bottle is kept and reused with subsequent purchases of dilutable concentrated products.

Either the water or concentrated fabric conditioner composition may be placed in the receptacle first. However, preferably the water is placed in the receptacle, followed by the concentrated fabric conditioner composition. This prevents foaming.

Although mixing may not be necessary, the consumer may shake or stir the diluted composition to ensure full dispersal of the concentrated fabric conditioner in the water.

Once the diluted fabric conditioner is made, this may be used according to regular dossing habits.

Preferably the ratio of concentrated fabric conditioner composition to water is 1:20 to 1:1 by weight, preferably 1:10 to 1:1.5, more preferably 1:10 to 1:2.

### EXAMPLES

TABLE 1
Example formulations

wt. % active

| | A | 1 |
|---|---|---|
| Fabric softening active¹ | 12.5 | 12.5 |
| Ethylenediaminetetraacetic acid | — | 0.85 |
| Non-ionic surfactant² | 7, | 7 |
| Perfume microcapsule | 0.2 | 0.2 |
| Perfume | 2 | 2 |
| Rheology modifier³ | 0.3 | 0.3 |
| Minors | <1 | <1 |
| Water | To 100 | To 100 |

Fabric softening active¹—Dihydrogenated Tallowethyl Hydroxyethylmonium Methosulphate
Non-ionic surfactant²—lauryl alcohol ethylene oxide (3EO)
Rheology modifier³—Sold under the trade name Flosoft ex. SNF

The formulations were prepared by heating water to ˜45° and adding the perfume microcapsules followed by the non-ionic surfactant and minors with stirring. The fabric softening active was pre-melted at ˜65° C. and added to the water with stirring. The rheology modifier was added with stirring. The mixture was cooled and the Ethylenediaminetetraacetic acid added (where present) followed by the perfume.

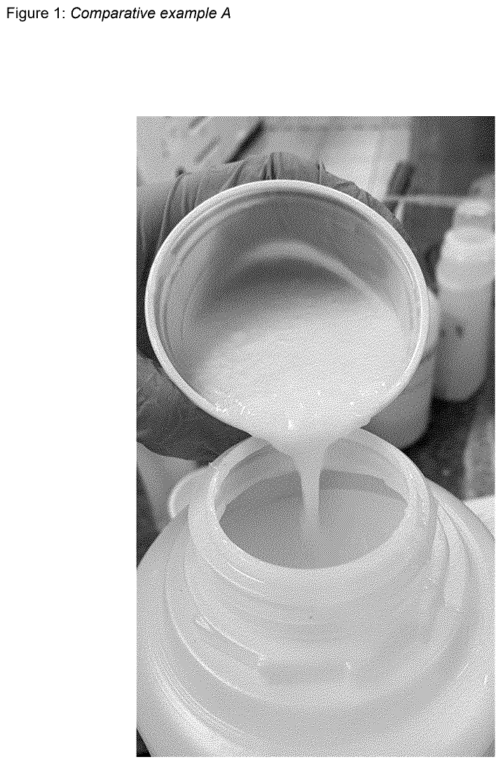

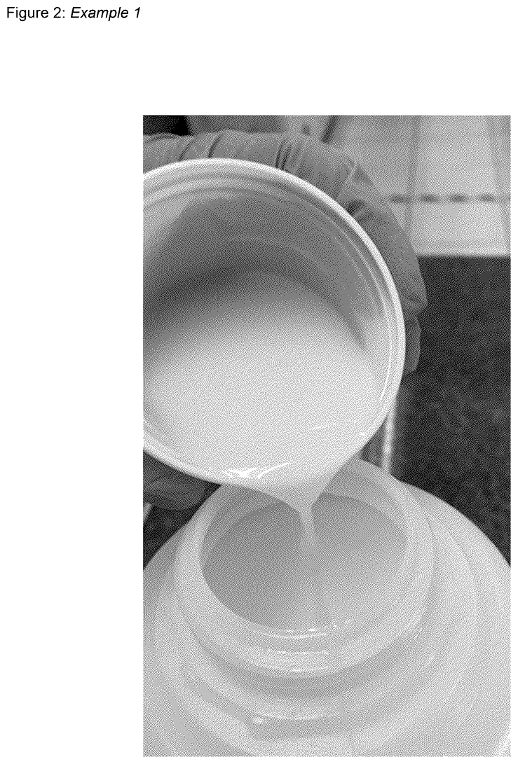

Once cooled to room temperature, a sample of each formulation was poured into a bottle. FIG. 1 is composition A being poured into a bottle. FIG. 2 is composition 1 being poured into a bottle. FIGS. 1 and 2 demonstrate that composition A is lumpy, whereas composition 1 has a superior viscosity.

1. A method of preparing a diluted fabric conditioner, wherein a concentrated fabric conditioner comprising:
a) 5 to 80 wt. % quaternary ammonium compound;
b) 0.01 to 10 wt. % ethylenediaminetetraacetic acid or a salt thereof;
c) 2 to 30 wt. % non-ionic surfactant;
is mixed with water, prior to addition to a laundry process;

2. (canceled)

3. The method according to claim 1, wherein the non-ionic surfactant comprises a fatty alcohol ethoxylate.

4. The method according to claim 1, wherein the concentrated fabric conditioner further comprises 0.01 wt. % to 2 wt. % rheology modifier.

5. The method according to claim 1, wherein the concentrated fabric conditioner has a viscosity of 300 mPa·s to 500 mPa·s measured using a Thermo Scientific Haake Viscotester 550 with a MV1 Sensor System for 15 seconds using 106 viscosity range with temperature of 25° C.

6. The method according to claim 1, wherein the concentrated fabric conditioner further comprises 0.1 to 15 wt. % free perfume.

7. The method according to claim 1, wherein the concentrated fabric conditioner further comprises 0.01 to 10 wt. % perfume microcapsules.

8. The method according to claim 1, wherein the concentrated fabric conditioner composition and water are present at a ratio from 1:20 to 1:1 by weight.

9. The method according to claim 1, wherein the diluted fabric conditioner is added to a rinse stage of the laundry process.

10. The method according to claim 7 wherein the perfume microcapsules further comprise zeolites or cyclodextrins.

11. The method according to claim 1 wherein the diluted fabric conditioner further comprises an antifoam, insect repellent, shading dye, hueing dye, preservative, pH buffering agent, hydrotrope, anti-redeposition agent, soil-release agent, polyelectrolyte, anti-shrinking agent, anti-wrinkle agent, anti-oxidant, sunscreens, anticorrosion agent, drape imparting agent, anti-static agent, sequestrant, ironing aid or a mixture thereof.

12. The method according to claim 1 wherein the diluted fabric conditioner further comprises pearliser, opacifier or both.

13. The method according to claim 1 wherein the diluted fabric conditioner is aqueous.

14. The method according to claim 13 wherein the diluted fabric conditioner comprises at least 50 wt. % water.

15. The method according to claim 4 wherein the rheology modifier comprises cationic acrylamide copolymer having a desalination coefficient (Cd) of greater than 0.6.
